(19) United States
(12) Patent Application Publication
(10) Pub. No.: US 2020/0034783 A1
(43) Pub. Date: Jan. 30, 2020

(54) STORE SYSTEM, ELECTRONIC SHELF LABEL, PROCESSING METHOD FOR STORE SYSTEM, AND NON-TRANSITORY STORAGE MEDIUM

(71) Applicant: NEC CORPORATION, Tokyo (JP)

(72) Inventor: Kazuki TSUCHIMOCHI, Tokyo (JP)

(73) Assignee: NEC CORPORATION, Tokyo (JP)

(21) Appl. No.: 16/498,691

(22) PCT Filed: Mar. 30, 2018
(86) PCT No.: PCT/JP2018/013766

§ 371 Date: Sep. 27, 2019

(30) Foreign Application Priority Data
Mar. 31, 2017 (JP) 2017-070084

(51) Int. Cl. G06Q 10/08; G09F 3/20

(52) U.S. Cl. CPC G06Q 10/087; G09F 3/208; G09F 3/204

(57) ABSTRACT

According to the present invention, there is provided a store system (10) including a plurality of information acquisition units (11) that are installed on a product display shelf unit so as to correspond to a plurality of products, respectively, a registration unit (12) that, when customer identification information is input through a first information acquisition unit (11), registers the customer identification information in a notification list in association with the product corresponding to the first information acquisition unit (11), and a transmission unit (13) that transmits relevant information of the product which is associated with each piece of customer identification information registered in the notification list to a transmission destination corresponding to the customer identification information.

### TECHNICAL FIELD

The present invention relates to a store system, an electronic shelf label, a processing method for the store system, and a program.

### BACKGROUND ART

Patent Document 1 discloses a stock check system which causes an electronic shelf label to have a function of making an inquiry on information such as stock. The electronic shelf label includes a request unit that requests stock information of a product when a prescribed input is detected, a reception unit that receives the stock information, a storage unit that stores the received stock information, and a display unit that displays the stored stock information.

In a case where the product is in stock, the display unit displays information such as “the product will be displayed on the shelf soon. Please wait for a while”. On the other hand, in a case where the product is not in stock, the display unit displays information such as “The product is currently out of stock. Expected next arrival date is February 1”.

### RELATED DOCUMENT

### Patent Document

[Patent Document 1] Japanese Patent Application Publication No. 2016-177744

### SUMMARY OF THE INVENTION

### Technical Problem

The technology disclosed in Patent Document 1 displays various pieces of information, such as existence and non-existence of stock and next expected arrival, on a display unit of the electronic shelf label. In this case, a customer should continuously wait at a location where the electronic shelf label exists until desired information is displayed on the display unit. Therefore, a problem occurs in that it is possible to provide only information which can be checked in a relatively short time and output, to the customer. An object of the present invention is to solve the problem.

### Solution to Problem

According to the present invention, there is provided a store system including:

a plurality of information acquisition units that are installed on a product display shelf unit so as to correspond to a plurality of products, respectively;

a registration unit that, when customer identification information is input through a first information acquisition unit, registers the customer identification information in a notification list in association with the product corresponding to the first information acquisition unit; and

a transmission unit that transmits relevant information of the product which is associated with each piece of customer identification information registered in the notification list to a transmission destination corresponding to the customer identification information.

In addition, according to the present invention, there is provided a store system including:

a plurality of buttons that are installed on a product display shelf unit so as to correspond to a plurality of products, respectively;

a plurality of displays that are installed on the product display shelf unit so as to correspond to the plurality of products, respectively;

a check unit that performs stock check of the product of which the button is pressed in response to a first press of the button;

a display control unit that displays a result of the stock check on the display corresponding to the product of which the button is pressed; and

a notification unit that provides a notification to a sales clerk in response to a press of the button in a state in which the result of the stock check is displayed on the display or a second press corresponding to a press of the button which is performed before a prescribed time elapses from an immediately previous press of the button,

in which the first press of the button includes a press of the button in a state in which the result of the stock check is not displayed on the display or a press of the button which is performed after the prescribed time elapses from the immediately previous press of the button.

In addition, according to the present invention, there is provided an electronic shelf label including:

a button that is installed on a product display shelf unit so as to correspond to a product;

a display that is installed on the product display shelf unit so as to correspond to the product; and

a transmission unit that transmits a signal, which causes stock check of the product to be performed, to a server in response to a first press of the button, and transmits a signal, which causes a notification to be provided to a sales clerk, in response to a press of the button in a state in which a result of the stock check is displayed on the display, or a second press corresponding to a press of the button, which is performed before a prescribed time elapses from an immediately previous press of the button,

the first press of the button includes a press of the button in a state in which the result of the stock check is not displayed on the display, or a press of the button, which is performed after the prescribed time elapses from the immediately previous press of the button.

In addition, according to the present invention, there is provided a processing method for a store system, which is executed by a computer of the store system that includes a plurality of information acquisition units installed on a product display shelf unit so as to correspond to a plurality of products, respectively, the method including:

a registration step of, in a case where customer identification information is input through a first information acquisition unit, registering the customer identification information in a notification list in association with the product corresponding to the first information acquisition unit; and

a transmission step of transmitting relevant information of the product which is associated with each piece of customer identification information registered in the notification list to a transmission destination corresponding to the customer identification information.

In addition, according to the present invention, there is provided a program causing a computer of a store system that includes a plurality of information acquisition units installed on a product display shelf unit so as to correspond to a plurality of products, respectively, to function as:

a registration unit that, when customer identification information is input through a first information acquisition unit, registers the customer identification information in a notification list in association with the product corresponding to the first information acquisition unit; and

a transmission unit that transmits relevant information of the product which is associated with each piece of customer identification information registered in the notification list to a transmission destination corresponding to the customer identification information.

In addition, according to the present invention, there is provided a processing method for a store system, which is executed by a computer of the store system that includes a plurality of buttons that are installed on a product display shelf unit so as to correspond to a plurality of products, respectively and a plurality of displays that are installed on the product display shelf unit so as to correspond to the plurality of products, respectively, the method including:

a check step of performing stock check of the product of which the button is pressed in response to a first press of the button;

a display control step of displaying a result of the stock check on the display corresponding to the product of which the button is pressed; and

a notification step of providing a notification to a sales clerk in response to a press of the button in a state in which the result of the stock check is displayed on the display or a second press corresponding to a press of the button, which is performed before a prescribed time elapses from an immediately previous press of the button,

in which the first press of the button includes a press of the button in a state in which the result of the stock check is not displayed on the display, or a press of the button, which is performed after the prescribed time elapses from the immediately previous press of the button.

In addition, according to the present invention, there is provided a program causing a computer of a store system that includes a plurality of buttons that are installed on a product display shelf unit so as to correspond to a plurality of products, respectively and a plurality of displays that are installed on the product display shelf unit so as to correspond to the plurality of products, respectively, to function as:

a check unit that performs stock check of the product of which the button is pressed in response to a first press of the button;

a display control unit that displays a result of the stock check on the display corresponding to the product of which the button is pressed; and

a notification unit that provides a notification to a sales clerk in response to a press of the button in a state in which the result of the stock check is displayed on the display or a second press corresponding to a press of the button, which is performed before a prescribed time elapses from an immediately previous press of the button,

in which the first press of the button includes a press of the button in a state in which the result of the stock check is not displayed on the display, or a press of the button, which is performed after the prescribed time elapses from the immediately previous press of the button.

### Advantageous Effects of Invention

According to the present invention, a new technology is realized which provides information that is relevant to a product displayed on a product display shelf unit to a customer.

### BRIEF DESCRIPTION OF THE DRAWINGS

The above-described object, other objects, features, and advantages will be further apparent with preferable example embodiments, which will be described below, and the accompanying drawings below.

FIG. 1 is a diagram conceptually illustrating an example of a hardware configuration of a store system of an example embodiment.

FIG. 2 is an example of a functional block diagram illustrating the store system of the example embodiment.

FIG. 3 is a diagram schematically illustrating an example of a product display shelf unit of the example embodiment.

FIG. 4 is a diagram schematically illustrating an example of data which is processed in the store system of the example embodiment.

FIG. 5 is a diagram schematically illustrating an example of the data which is processed in the store system of the example embodiment.

FIG. 6 is a diagram schematically illustrating an example of the data which is processed in the store system of the example embodiment.

FIG. 7 is a flowchart illustrating an example of a flow of a process performed by the store system of the example embodiment.

FIG. 8 is a flowchart illustrating the example of the flow of the process performed by the store system of the example embodiment.

FIG. 9 is an example of a functional block diagram of the store system of the example embodiment.

FIG. 10 is a diagram schematically illustrating an example of the product display shelf unit of the example embodiment.

FIG. 11 is a flowchart illustrating an example of the flow of the process performed by the store system of the example embodiment.

FIG. 12 is an example of the functional block diagram of the store system of the example embodiment.

FIG. 13 is a diagram schematically illustrating an example of the product display shelf unit of the example embodiment.

FIG. 14 is a flowchart illustrating an example of the flow of the process performed by the store system of the example embodiment.

FIG. 15 is a diagram schematically illustrating an example of information displayed in the store system of the example embodiment.

FIG. 16 is an example of a functional block diagram of an electronic shelf label of the example embodiment.

### DESCRIPTION OF EMBODIMENTS

### First Example Embodiment

First, an outline of a store system of an example embodiment will be described. The store system includes a plurality of information acquisition units, a registration unit, and a transmission unit.

Each of the plurality of information acquisition units is installed on a product display shelf unit so as to correspond to each of a plurality of products. The information acquisition unit acquires customer identification information from an electronic card, an electronic tag, a mobile terminal, or the like, which stores the customer identification information.

In a case where the customer identification information is input through any one (first information acquisition unit) of the plurality of information acquisition units, the registration unit registers the customer identification information in a notification list in association with the product corresponding to the first information acquisition unit.

The transmission unit transmits information relevant to the product, which is associated with each piece of customer identification information in the notification list, to a transmission destination corresponding to the customer identification information registered in the notification list. For example, the transmission unit transmits the relevant information which includes at least one of an expected next arrival date of the product, a next arrival date of the product (fixed next arrival date. The same hereinafter.), an arrival notification, which is performed after the product actually arrives, of the product, and an URL. It is possible for the transmission unit to transmit the relevant information to a prescribed transmission destination through electronic mail transmission, application push notification, and the like.

According to the store system, the customer performs a “simple operation” of causing the information acquisition unit corresponding to a product of interest in the store to read the customer identification information of the customer, and thereby it is possible for the customer to acquire the relevant information of the product in a form of, thereafter, having the relevant information sent to a transmission destination of the customer. Furthermore, it is possible for the customer to check the received relevant information at any timing in any location. In this case, a limitation of “information which can be checked and be output in a relatively short time” is not required for information provided to the customer. Therefore, it is possible to provide various pieces of information.

Subsequently, a configuration of the store system will be described in detail. First, an example of a hardware configuration of the store system will be described. The store system is configured by any combination of hardware and software of any computer focusing on a Central Processing Unit (CPU), a memory, a program which is loaded on the memory, a storage unit (which is capable of storing a program which is downloaded from a storage medium, such as a Compact Disc (CD), a server on the Internet, or the like, in addition to a program that is previously stored at the stage of shipping an apparatus), such as a hard disk, which stores the program, and based on an interface for network connection. Furthermore, those skilled in the art understand that various modification examples exist for a method and an apparatus, which realize the store system.

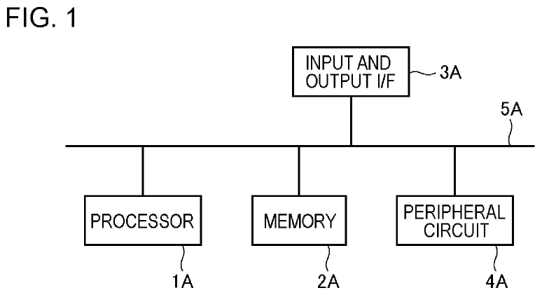

FIG. 1 is a block diagram illustrating the hardware configuration of the store system. As illustrated in FIG. 1, the store system includes a processor 1A, a memory 2A, an input and output interface 3A, a peripheral circuit 4A, and a bus 5A. The peripheral circuit 4A includes various modules.

The bus 5A is a data transmission path which is used for the processor 1A, the memory 2A, the peripheral circuit 4A, and the input and output interface 3A to transmit and receive data to and from each other. The processor 1A is, for example, an arithmetic processing unit such as the Central Processing Unit (CPU) or a Graphics Processing Unit (GPU). The memory 2A is, for example, a memory such as a Random Access Memory (RAM) or a Read Only Memory (ROM). The input and output interface 3A includes an interface which is used to acquire information from an input apparatus (for example: a keyboard, a mouse, a microphone, a physical key, a touch panel display, a reader, or the like), an external apparatus, an external server, an external sensor, and the like, and an interface which is used to output information to an output apparatus (for example: a display, a speaker, a printer, an emailer, or the like), the external apparatus, the external server, and the like. It is possible for the processor 1A to output an instruction to each of the modules and to perform an arithmetic operation on the basis of an arithmetic result of each of the modules.

The store system may be formed by one apparatus which is physically and/or logically integrated, or a plurality of apparatuses which are physically and/or logically separated. In a case where the store system is formed by the plurality of apparatuses, the plurality of apparatuses are formed to transmit and receive information to and from each other, and the plurality of apparatuses cooperatively implement a function of an analysis system.

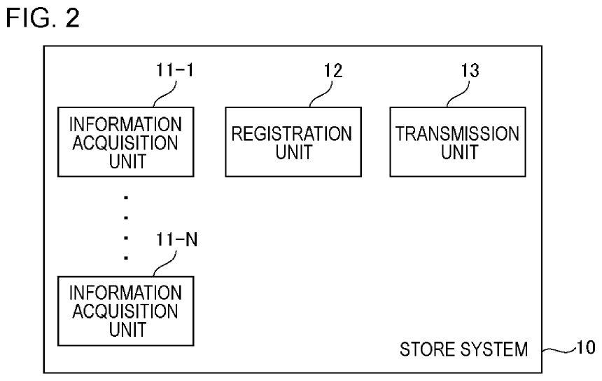

FIG. 2 illustrates an example of a functional block diagram of a store system 10. As illustrated in the drawing, the store system 10 includes a plurality of information acquisition units 11-1 to 11-N (N is an integer which is equal to or larger than 2), a registration unit 12, and a transmission unit 13.

The plurality of information acquisition units 11-1 to 11-N are N apparatuses which are physically separated from each other. Furthermore, the registration unit 12 and the transmission unit 13 are provided in a server which is physically separated from the plurality of information acquisition units 11-1 to 11-N. Hereinafter, the server, which includes the registration unit 12 and the transmission unit 13, is simply referred to as a “server”. Each of the plurality of information acquisition units 11-1 to 11-N and the server are configured in a communicable manner.

The information acquisition units 11-1 to 11-N acquire the customer identification information (customer ID (identifier)). The information acquisition units 11-1 to 11-N may be, for example, a reader which communicates with the electronic card (for example: an Integrated Circuit (IC) card), the electronic tag (for example: an IC tag), the mobile terminal (for example: a smart phone, a mobile phone, or the like), and the like in contact or contactless manner, and which acquires the customer ID stored therein. In addition, the information acquisition units 11-1 to 11-N may be physical keys or touch panel displays, and an input of the customer ID may be received directly therethrough. In addition, the information acquisition units 11-1 to 11-N may be a camera, a fingerprint sensor, a microphone, or the like, and may acquire biometric information such as a facial image, an iris, a fingerprint, or a voiceprint. In this case, the biometric feature amount of each piece of customer is previously registered in association with the customer ID, and a prescribed customer ID is extracted using the registered information and the biometric information which is input through the information acquisition units 11-1 to 11-N.

Each of the information acquisition units 11-1 to 11-N is installed on the product display shelf unit so as to correspond to each of the plurality of products. Each of the information acquisition units 11-1 to 11-N transmits, for example, information, which is used to identify the corresponding product, to the server in association with the acquired customer ID. In this case, each of the information acquisition units 11-1 to 11-N previously stores the information which is used to identify the corresponding product. In addition, each of the information acquisition units 11-1 to 11-N may transmit information, which is used to identify a terminal of the information acquisition unit (for example: the reader), to the server in association with the acquired customer ID. In this case, each of the information acquisition units 11-1 to 11-N previously stores the information which is used to identify the own terminal. In addition, the server maintains correspondence information in which each of the information acquisition units 11-1 to 11-N is associated with the product corresponding to the information acquisition unit

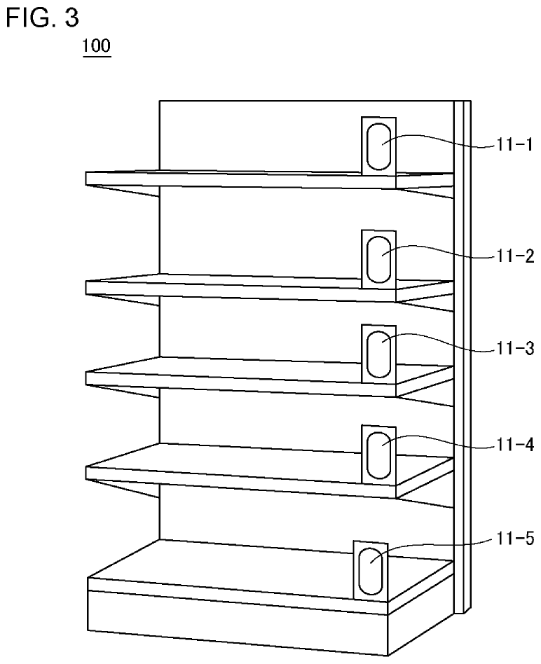

FIG. 3 schematically illustrates an example of a product display shelf unit 100. The drawing shows the product display shelf unit 100 having five levels. In the product display shelf unit 100, 5 types of products (not illustrated in the drawing) are displayed. One level is assigned to each of the 5 types of products. Furthermore, the information acquisition units 11-1 to 11-5 are provided to correspond to the respective levels. In the drawing, readers which are examples of the information acquisition units 11-1 to 11-N are displayed.

Returning to FIG. 2, in a case where the customer ID is input through a first information acquisition unit 11-A (A is an integer which is equal to or larger than 1 and is equal to or less than N) which is any one of the information acquisition units 11-1 to 11-N, the registration unit 12 registers the product corresponding to the first information acquisition unit 11-A in the notification list in association with the customer ID.

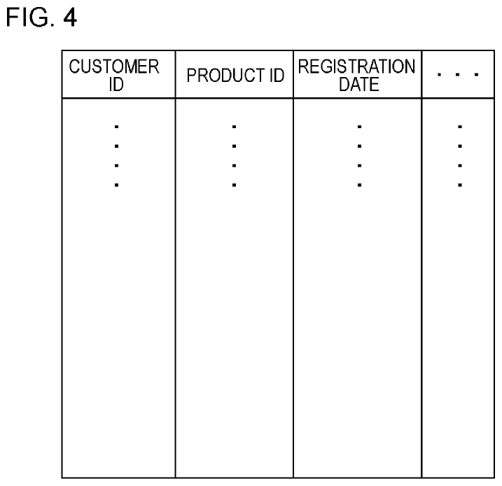

FIG. 4 schematically illustrates an example of the notification list. In the notification list illustrated in the drawing, the customer ID, a product ID, and a registration date are associated with each other. The customer ID is information which is used to distinguish a plurality of customers from each other. The product ID is information which is used to distinguish the plurality of products from each other. The registration date is a date which is registered in the notification list.

Returning to FIG. 2, the transmission unit 13 transmits the relevant information of the product, which is associated with each of the customer IDs in the notification list, to a transmission destination corresponding to the customer ID registered in the notification list.

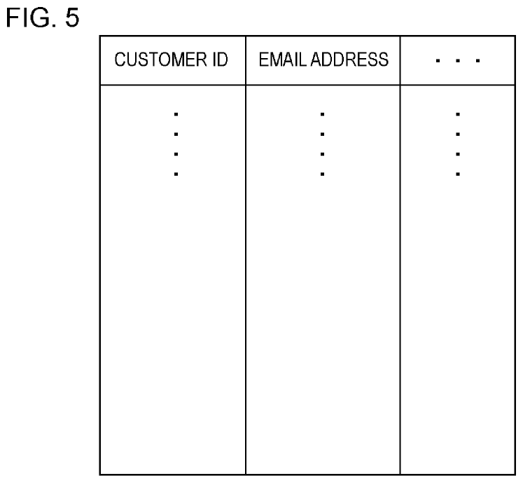

For example, as illustrated in FIG. 5, an email address (transmission destination) may be previously registered in association with each of the plurality of customer IDs. Furthermore, the transmission unit 13 may execute transmission of the relevant information using the registered information.

In addition, the customer may install a dedicated application, which is used to receive the relevant information, in a terminal (for example: the smart phone, a tablet, the mobile phone, or the like) of the customer, and may register the customer ID of the customer. Furthermore, the transmission unit 13 may transmit the relevant information to the terminal (transmission destination) using a push notification function of the application.

The relevant information includes at least one of the expected next arrival date of the product, the next arrival date of the product, the arrival notification, which is performed after the product actually arrives, of the product, and the URL.

Here, an example of a means that checks the expected next arrival date of the product, the next arrival date of the product, and a fact that the product actually arrives will be described. It should be noted that, the transmission unit 13 may check the expected next arrival date of the product, the next arrival date of the product, and the fact that the product actually arrives using another means, and may transmit a result of the check to the customer as the relevant information.

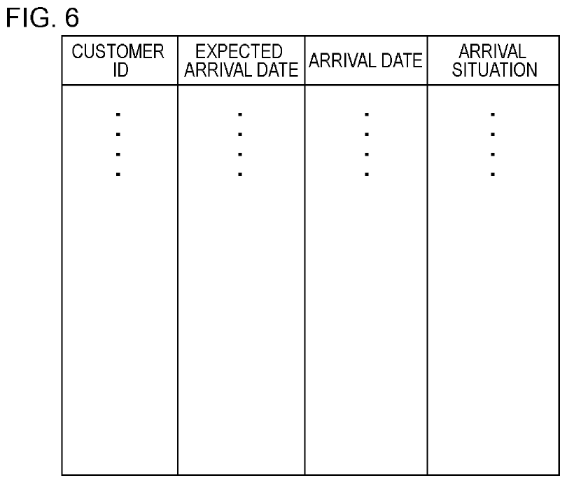

For example, the store system 10 or another apparatus manages an order history as illustrated in FIG. 6. Furthermore, the transmission unit 13 acquires the relevant information as described above on the basis of the order history. The order history illustrated in FIG. 6 is registered with the expected arrival date, the arrival date of the product, and an arrival situation, which indicates whether or not the product has already arrived, in association with each of the plurality of products which has been ordered. An operation of registering each value of the order history may be manually performed by a sales clerk or may be performed through a process using the computer.

For example, each of the products, which are ordered from a maker or a head office by each store, is registered in the order history. Furthermore, a desired arrival date specified in the order is registered as the expected arrival date of each of the products. In a case where an order operation is performed through the computer, the registration operation is performed through the process using the computer.

In addition, for example, in a case where an answer with respect to the order is acquired from the maker or the head office, an arrival date (fixed date) of each of the products included in the answer is registered as the arrival date of the product. In a case where transmission and reception of the answer are performed through the computer, the registration operation is performed through the process using the computer.

In addition, for example, in a case where a notification of the arrival date (fixed date) of the ordered product is acquired from a deliverer who delivers the product, the arrival date included in the notification is registered as the arrival date of the product. In a case where transmission and reception of the notification is performed through the computer, the registration operation is performed through the process using the computer.

In addition, for example, in a case where the ordered product arrives at the store, the product having arrived is registered in an “arrival situation” field corresponding to the product. For example, an operation of inspecting the arrived product is performed by the sales clerk using a Point Of Sale (POS) terminal, and thereby each product having arrived is registered in the POS system. The information is used, and thereby the registration operation is performed through the process using the computer.

It is possible for the transmission unit 13 to transmit the expected arrival date, which is registered in association with a certain product (first product) before arrival, as the “expected next arrival date” to the transmission destination, which is associated with the first product in the notification list, of one or more customers.

For example, in a case where, when a first customer is registered in the notification list in association with the first product, the first product which is before arrival and of which the expected arrival date has been fixed is registered in the order history illustrated in FIG. 6, the transmission unit 13 may notify the expected next arrival date of the first product to the first customer according to the registration in the notification list. In addition, in a case where, when the first customer is registered in the notification list in association with the first product, the first product which is before arrival and of which the expected arrival date has been fixed is not registered in the order history illustrated in FIG. 6, the transmission unit 13 may thereafter notify the expected next arrival date of the first product to the first customer according to the registration in the notification list when the first product which is before arrival and of which the expected arrival date has been fixed appears in the order history illustrated in FIG. 6.

In addition, it is possible for the transmission unit 13 to transmit the arrival date which is registered in association with the first product which is before arrival, as the “next arrival date” to the transmission destination, which is associated with the first product in the notification list, of one or more customers.

For example, in a case where, when the first customer is registered in the notification list in association with the first product, the first product which is before arrival and of which the expected arrival date is fixed is registered in the order history illustrated in FIG. 6, the transmission unit 13 may notify the next arrival date of the first product to the first customer according to the registration in the notification list. In addition, in a case where, when the first customer is registered in the notification list in association with the first product, the first product which is before arrival and of which the expected arrival date is fixed is not registered in the order history illustrated in FIG. 6, the transmission unit 13 may thereafter notify the expected next arrival date of the first product to the first customer according to the registration in the notification list when the first product which is before arrival and of which the arrival date is fixed appears in the order history illustrated in FIG. 6.

In addition, in a case where the arrival situation which is registered in association with the first product which is before arrival is updated to “a value which indicates that the first product has arrived”, the transmission unit 13 may transmit information which indicates that effect to the transmission destination, which is associated with the first product, of one or more customers.

Subsequently, the URL which can be included in the relevant information will be described. The transmission unit 13 transmits the URL as described below to a prescribed transmission destination at any timing.

The URL may be a URL of a website which is used to specify whether or not to reserve the product. A configuration of the website is a design matter. The customer decides whether or not to purchase the product at the store on the basis of various pieces of information (for example: the expected next arrival date of the product, the next arrival date, and the arrival notification) received as the relevant information. Furthermore, in a case where the customer decides to purchase the product, the customer operates any communication terminal, accesses a prescribed website which is specified by the URL, and performs a “reservation request for the product”. The store reserves a prescribed product for a prescribed customer on the basis of the reservation request from the customer.

In addition, the URL may be a URL of a website which is used to perform a product settlement procedure. The configuration of the website is a design matter. The customer decides whether or not to purchase the product at the store on the basis of various pieces of information (for example: the expected next arrival date, the next arrival date, and the arrival notification of the product) received as the relevant information. Furthermore, in a case where it is decided to purchase the product, the customer operates any communication terminal, accesses the prescribed website which is specified by the URL, and performs the “settlement procedure for the product”. That is, the customer makes settlement for the product or the like on the website, and purchases the product.

In this case, the website may receive a specification of a method for receiving the product. As the method for receiving the product, it may be possible to specify at least one of receipt at a store and delivery to a specified address. In a former case, it may be possible to specify a store for the receipt on the website. In addition, in a latter case, it may be possible to specify an address of a delivery destination on the website. The store reserves a product, on which the settlement is completed, for the prescribed customer or prepares delivery of the product, on which the settlement is completed, for the prescribed customer on the basis of a process performed by the customer on the web.

It should be noted that, the store system 10 may remove from the notification list a customer to whom the various pieces of relevant information have been sent, or may register a gist that the notification is completed. Thereafter, the relevant information is not transmitted to the customer on whom the above process is performed.

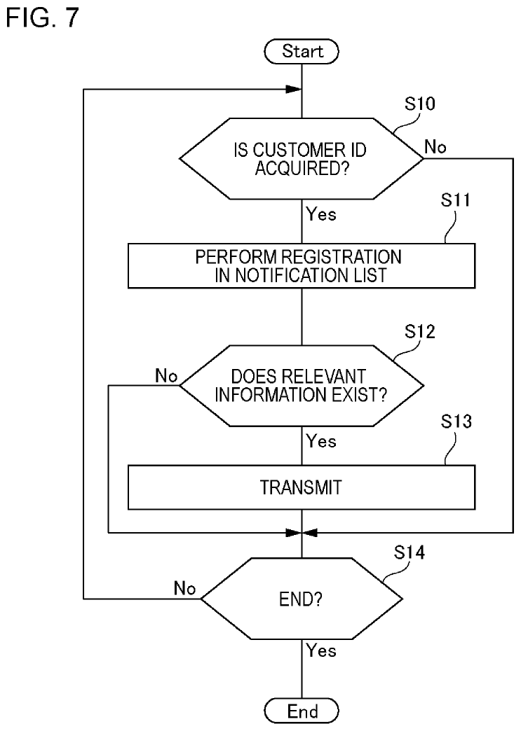

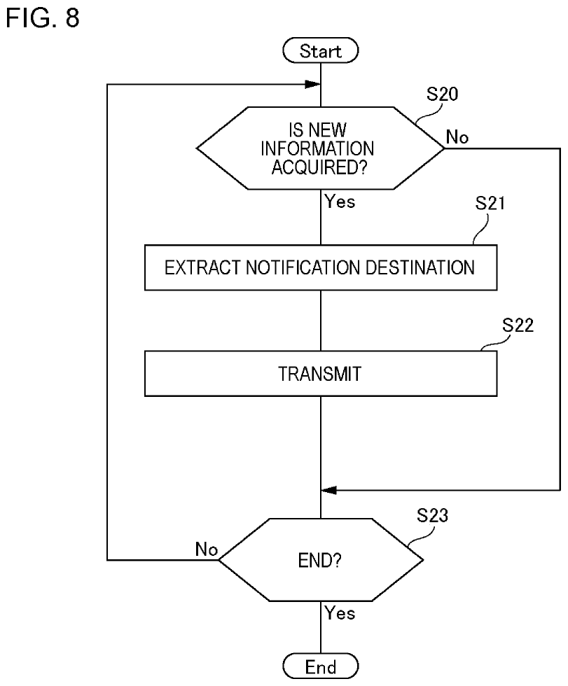

Subsequently, an example of a flow of a process performed by the store system 10 of the example embodiment will be described with reference to flowcharts of FIGS. 7 and 8.

FIG. 7 illustrates a flow of a process of performing registration in the notification list and a process of transmitting the relevant information to the customer. The store system 10 is in a waiting state for an input of the customer ID through the plurality of information acquisition units 11-1 to 11-N (S10). While there is no input to end the process (No in S14), the store system 10 continues the waiting state.

In a case where any first information acquisition unit 11-A acquires the customer ID (Yes in S10), the registration unit 12 of the store system 10 registers the customer ID in the notification list in association with the product (first product) corresponding to the first information acquisition unit 11-A (S11).

Thereafter, the transmission unit 13 of the store system 10 checks whether or not the relevant information to be notified to a newly registered customer exists at that time point (S12).

For example, the transmission unit 13 checks whether or not the first product which is before arrival and of which the expected arrival date or the arrival date is fixed is registered in the order history illustrated in FIG. 6. Furthermore, in a case where there is the registration thereof, the transmission unit 13 decides that the relevant information to be notified to the customer exists (Yes in S12). Furthermore, the transmission unit 13 transmits the expected next arrival date, the next arrival date, or the like of the product to the customer (S13).

In addition, it is possible for the transmission unit 13 to transmit a prescribed URL to the customer at any timing. For example, the transmission unit 13 transmits the prescribed URL to the customer, together with the expected next arrival date, the next arrival date, or the like. The prescribed URL is as described above. Thereafter, while there is no input to end the process (No in S14), the store system 10 repeats the same process.

FIG. 8 illustrates a flow of the process of transmitting the relevant information to the customer. The store system 10 is in a waiting state for new information (new relevant information) (S20). While there is no input to end the process (No in S23), the store system 10 continues the waiting state.

In a case where new information is acquired (for example: the order history of FIG. 6 is updated) (Yes in S20), the transmission unit 13 determines to what product the new information is relevant, and, thereafter, extracts a customer associated with the determined product in the notification list as a notification destination (S21). Furthermore, the transmission unit 13 transmits the new information toward the extracted customer (S22). Thereafter, while there is no input to end the process (No in S23), the store system 10 repeats the same process.

According to the above-described store system 10 of the example embodiment, the customer performs the “simple operation” of causing the information acquisition units 11-1 to 11-N corresponding to the product of interest in the store to read the customer identification information of the customer, and thereby it is possible for the customer to acquire the relevant information of the product in a form of, thereafter, having the relevant information sent to the transmission destination of the customer. In this case, a limit of “information which can be checked and can be output in a relatively short time” is not required in the information which is provided to the customer. Therefore, it is possible to provide various pieces of information to the customer.

For example, in a case of a sold-out state of a product which is desired to be purchased, in a case where the number of displayed products is less than the number desired to be purchased, or the like, it is possible for the customer to cause the information acquisition units 11-1 to -N corresponding to the product to read the customer identification information of the customer. Then, thereafter, the expected next arrival date of the product, the next arrival date, the arrival notification, or the like is transmitted to the transmission destination of the customer. The customer checks a message which is transmitted at any location at any timing, and thus it is possible for the customer to read the relevant information. Furthermore, it is possible for the customer to decide whether or not to purchase the product at the store on the basis of such useful information.

In addition, it is possible for the store system 10 to provide the URL of the website, which is used to specify whether or not to reserve the product, to the customer as the relevant information. In a case where the customer decides to purchase the product at the store on the basis of the various pieces of information (for example: the expected next arrival date of the product, the next arrival date, and the arrival notification) received as the relevant information, it is possible for the customer to access the prescribed website which is specified by the URL and to perform the “reservation request for the product”. Therefore, it is possible for the customer to prevent a trouble in which all the products whose arrival has been checked are sold out and out of stock when the customer goes to the store.

In addition, it is possible for the store system 10 to provide the URL of the website, which is used to perform settlement procedure for a product, to the customer as the relevant information. In a case where the customer decides to purchase the product at the store on the basis of the various pieces of information (for example: the expected next arrival date of the product, the next arrival date, and the arrival notification) received as the relevant information, it is possible for the customer to access the prescribed website which is specified by the URL and to perform the “settlement procedure for the process”. Therefore, it is possible for the customer to prevent a trouble in which it is not possible to purchase the product. In addition, in a case where the delivery to the specified address is selected as the method for receiving the product, it is possible to prevent a troublesome operation of going to the store again.

In addition, on a side of the store, the various pieces of relevant information are provided to the customer, and thus it is possible to reduce a trouble in which a sales opportunity is missed, and it is possible to increase sales.

### Second Example Embodiment

A store system 10 of a second example embodiment includes a unit that receives a stock check request for each of the plurality of products, a unit that provides a result thereof to the customer, and the like, in addition to the configuration described in the first example embodiment. Hereinafter, description will be performed.

An example of a hardware configuration of the store system 10 is the same as in the first example embodiment.

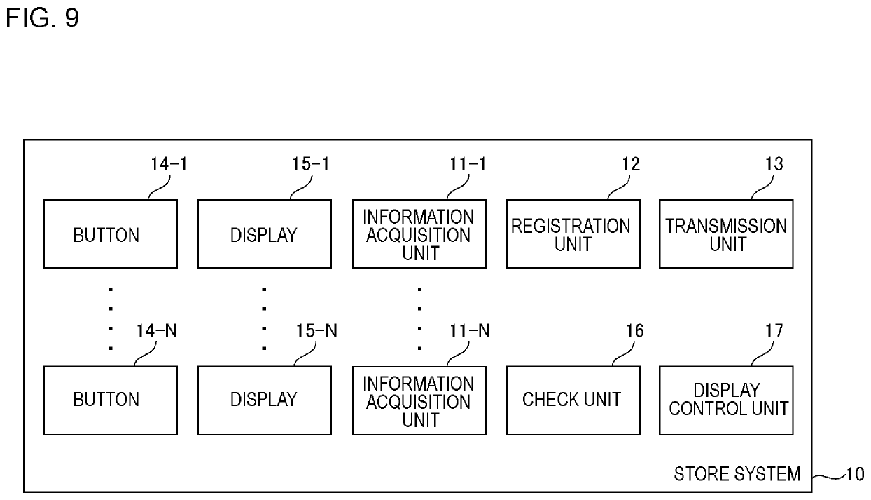

FIG. 9 illustrates an example of a function block diagram of the store system 10. As illustrated in the drawing, the store system 10 includes a plurality of information acquisition units 11-1 to 11-N (N is an integer which is equal to or larger than 2), a registration unit 12, a transmission unit 13, a plurality of buttons 14-1 to 14-N, a plurality of displays 15-1 to 15-N, a check unit 16, and a display control unit 17. The check unit 16 is included in a server. The plurality of displays 15-1 to 15-N are included in respective N apparatuses (electronic shelf labels) which are physically separated from each other. The display control unit 17 may be included in the server or may be included in the respective N apparatuses (electronic shelf labels) which include the plurality of displays 15-1 to 15-N, respectively.

The configuration of the information acquisition units 11-1 to 11-N (N is an integer which is equal to or larger than 2), the registration unit 12, and the transmission unit 13 is the same that of the first example embodiment.

The buttons 14-1 to 14-N are installed on the product display shelf unit so as to correspond to the plurality of respective products. The plurality of buttons 14-1 to 14-N may be physical buttons, or may be buttons which are displayed on touch panel displays in a case where the displays 15-1 to 15-N are the touch panel displays.

The displays 15-1 to 15-N are installed on the product display shelf unit so as to correspond to the plurality of respective products.

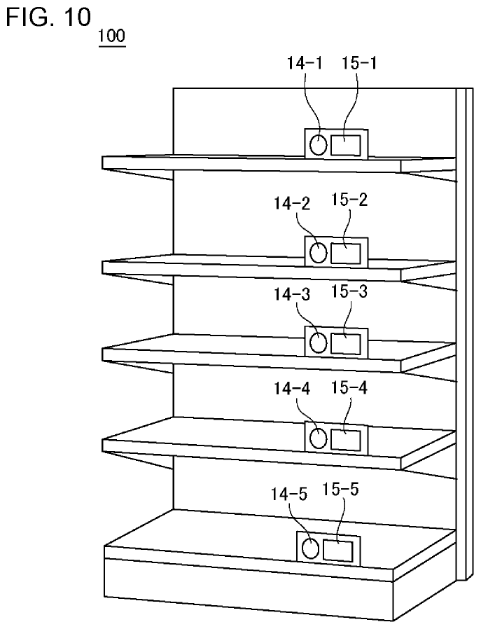

FIG. 10 schematically illustrates an example of the product display shelf unit 100 of the example embodiment. In the drawing, the product display shelf unit 100 having five levels is displayed. In the product display shelf unit 100, 5 types of products (not illustrated in the drawing) are displayed. One level is assigned to each of the 5 types of products. Furthermore, the information acquisition units 11-1 to 11-5, the buttons 14-1 to 14-N, and the displays 15-1 to 15-5 are installed to correspond to the respective levels. In the drawing, readers which are examples of the information acquisition units 11-1 to 11-N are displayed.

Returning to FIG. 9, in a case where any button 14-B (B is an integer which is equal to or larger than 1 and is equal to or less than N) of the plurality of buttons 14-1 to 14-N is pressed, the check unit 16 checks stock of the product corresponding to the button 14-B. That is, in a case where any of the plurality of buttons 14-1 to 14-N is pressed, a notification that any of the plurality of buttons 14-1 to 14-N is pressed is provided to the check unit 16.

Here, the stock is the stock of a product which is not displayed on the product display shelf unit 100 but is stored in the store.

Although means that checks the stock is not particularly limited, an example will be described below. For example, a stock list, in which a product that is in stock is registered, may be previously prepared. Furthermore, the check unit 16 may determine existence and non-existence of the stock of each product by checking the stock list.

A method for preparing the stock list is not particularly limited. For example, the stock list may be prepared through manual input by the sales clerk.

In addition, the stock list may be generated through the process using the computer. For example, an image file, which is acquired by capturing products in stock, may be input to the computer. Furthermore, the computer may determine the products in stock and may prepare the stock list on the basis of a result of the determination through a collation process using the image file and a feature value of an appearance of each of the plurality of products that are previously registered.

For example, the image file, which includes the plurality of products in stock, may be generated by capturing a location where the products in stock are collectively stored. The sales clerk may perform capture using a camera by hands or may perform capture using a fixed camera.

The display control unit 17 displays a result of stock check on a display 15-B corresponding to the product, on which any button 14-B is pressed. For example, the display control unit 17 displays the existence and non-existence of the stock on the display 15-B.

The display control unit 17 may display another information on the display 15-B. It should be noted that, it is preferable that the information to be displayed needs little time for to be checked and output. In this manner, it is possible to reduce time in which the customer is kept in front of the display 15-B waiting for information to be displayed. For example, in a case where the product corresponding to the button 14-B is registered in a state where the product is before arrival and the expected arrival date or the arrival date thereof is fixed in the order history illustrated in FIG. 6 at a point of time in which the button 14-B is pressed, the display control unit 17 may display the expected next arrival date of the product, the next arrival date, or the like on the display 15-B.

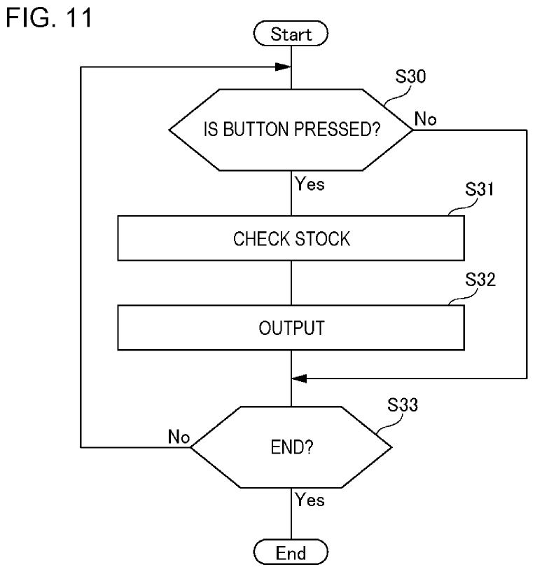

Subsequently, an example of a flow of a process performed by the store system 10 of the example embodiment will be described using the flowchart of FIG. 11. It should be noted that, it is possible for the store system 10 to perform, in addition to the process, the processes which are illustrated in the flowcharts of FIGS. 7 and 8 described in the first example embodiment. For example, in an actual shopping scene, it is considered that the customer performs an operation of acquiring the relevant information after performing the stock check. The stock check is performed through the flow of FIG. 11 which will be described below. The acquisition of the relevant information is performed through the flows of FIGS. 7 and 8.

The store system 10 is in a waiting state for the press of the plurality of buttons 14-1 to 14-N (S30). While there is no input to end the process (No in S33), the store system 10 continues the waiting state.

In a case where any button 14-B is pressed (Yes in S30), the check unit 16 of the store system 10 performs the stock check of the product corresponding to the button 14-B (S31). Furthermore, the display control unit 17 of the store system 10 displays a result of the stock check on the display 15-B corresponding to the product (S32). Thereafter, while there is no input to end the process (No in S33), the store system 10 repeats the same process.

Hereinabove, according to the described store system 10 of the example embodiment, it is possible to achieve the same advantageous effect as in the first example embodiment.

In addition, according to the store system 10 of the example embodiment, it is possible to display the information, which needs little time for the check and the output of result of the stock check or the like, on the displays 15-1 to 15-N which are installed on the product display shelf unit 100. It is possible for the customer to rapidly recognize the result of the stock check or the like in the place.

### Third Example Embodiment

A store system 20 of a third example embodiment includes the plurality of buttons 14-1 to 14-N and the plurality of displays 15-1 to 15-N which are described in the second example embodiment. Furthermore, in a case where any button 14-B is pressed (first press), the store system 20 displays the result of the stock check on the display 15-B. In a case where the button 14-B is pressed again (second press), the store system 20 provides a notification that the button 14-B is pressed to the sales clerk. Hereinafter, description will be performed.

An example of a hardware configuration of the store system 20 is the same as that of the store system 10 of the first and second example embodiments.

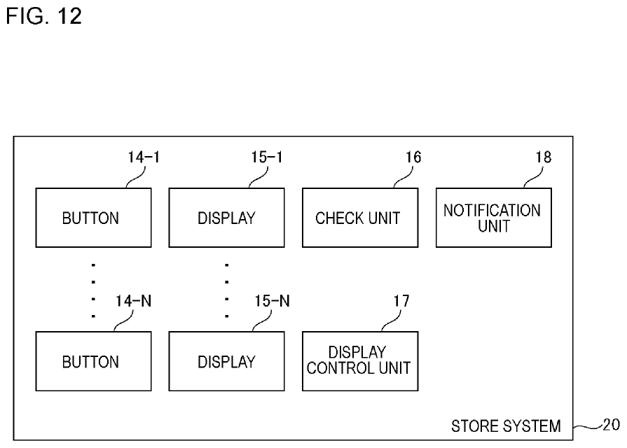

FIG. 12 illustrates an example of a function block diagram of the store system 20. As illustrated in the drawing, the store system 20 includes a plurality of buttons 14-1 to 14-N (N is an integer which is equal to or larger than 2), a plurality of displays 15-1 to 15-N, a check unit 16, a display control unit 17, and a notification unit 18. Although not illustrated in the drawing, the store system 20 may further include a plurality of information acquisition units 11-1 to 11-N, a registration unit 12, and a transmission unit 13. The notification unit 18 is included in a server.

A configuration of the plurality of information acquisition units 11-1 to 11-N, the registration unit 12, the transmission unit 13, the plurality of buttons 14-1 to 14-N, and the plurality of displays 15-1 to 15-N is the same as those of the first and second example embodiments.

The check unit 16 performs stock check of a product corresponding to the button 14-B in response to the first press of the button 14-B. The first press of the button 14-B includes the press of the button 14-B in a state in which the result of the stock check is not displayed on the display 15-B or the press of the button 14-B which is performed after a prescribed time (design matter) elapses from an immediately previous press of the button 14-B. It should be noted that, a stock check process performed by the check unit 16 is the same as that of the second example embodiment.

The display control unit 17 displays the result of the stock check performed by the check unit 16 on the display 14-B corresponding to the button 14-B during the prescribed time (design matter). That is, when the prescribed time elapses from a point of time in which display of the result of the stock check is started, the display of the result of the stock check on the display 15-B ends. Another configuration of the display control unit 17 is the same as that of the second example embodiment.

The notification unit 18 provides a notification of the second press of the button 14-B to the sales clerk in response to the second press of the button 14-B. The second press of the button 14-B includes a press of the button 14-B in a state in which the result of the stock check is displayed on the display 15-B or a press of the button 14-B which is performed before the prescribed time (design matter) elapses from the immediately previous press of the button 14-B. Contents of the notification include, for example, a notification which is used to request replenishment of a display product or a notification which is used to call the sales clerk to the customer.

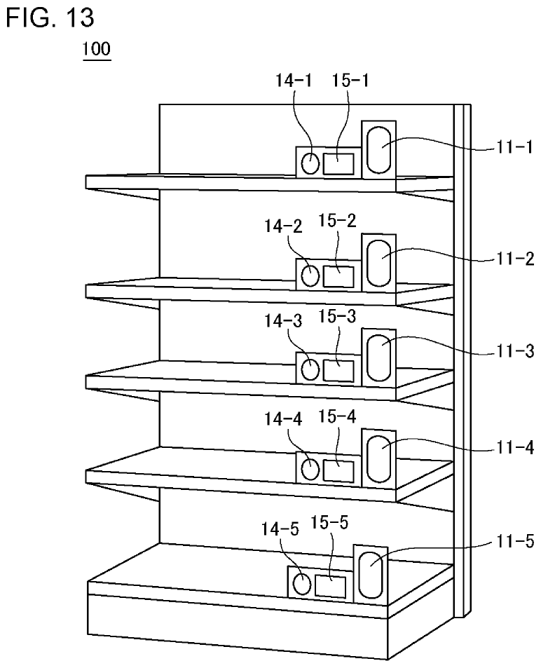

Here, FIG. 13 schematically illustrates an example of the product display shelf unit 100 of the example embodiment. In the drawing, a product display shelf unit 100 having five levels is displayed. In the product display shelf unit 100, 5 types of products (not illustrated in the drawing) are displayed. One level is assigned to each of the 5 types of products. Furthermore, the buttons 14-1 to 14-N and the displays 15-1 to 15-5 are installed to correspond to the respective levels. It should be noted that, the information acquisition units 11-1 to 11-N may be further installed to correspond to the respective levels.

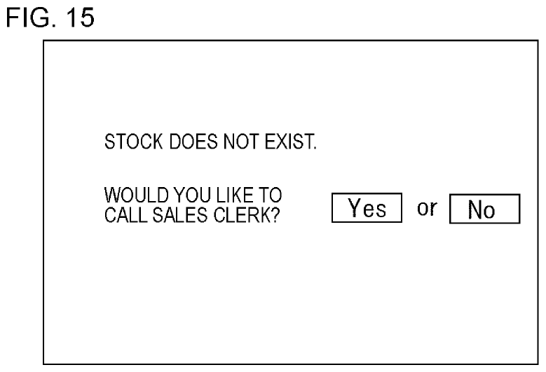

It should be noted that, it is possible for the display control unit 17 to display information, which is used to cause the customer to select whether or not to call the sales clerk, on the display 15-B, together with the result of the stock check. FIG. 15 illustrates an example of the information which is displayed on the display 15-B. In the example, in a case where it is selected to call the sales clerk by the customer, the notification unit 18 provides a notification that it is selected to call the sales clerk to the sales clerk.

However, in a case where the button 14-B is pressed, the store system 10 of the example embodiment as described above classifies the press as any of the “first press” or the “second press” each time. Regardless of the accumulated number of times that the button 14-B is pressed or the number of times that the button 14-B is continuously pressed by the same person, the store system 10 classifies each press as any of the “first press” or the “second press”.

When the button 14-B is pressed, it is necessary for the store system 10 of the example embodiment to decide whether the press is the “first press” or the “second press”. The decision may be performed by the server or may be performed by the electronic shelf label which includes the button 14-B and the display 15-B.

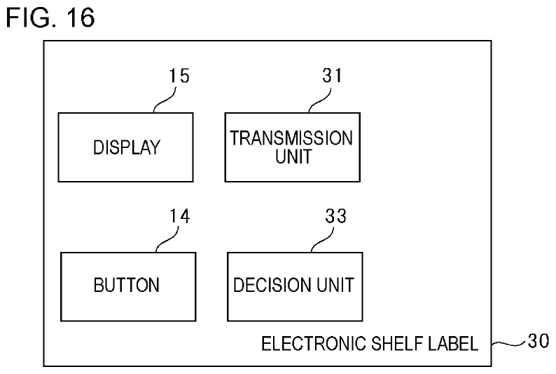

Here, FIG. 16 illustrates an example of a function block diagram of the electronic shelf label 30 which performs the decision. The store system 20 of the example embodiment includes a plurality of electronic shelf labels 30. Each of the plurality of electronic shelf labels 30 is installed to correspond to the product on the product display shelf unit 100.

As illustrated in FIG. 16, each of the electronic shelf labels 30 includes a button 14, a display 15, a transmission unit 31, and a decision unit 33.

The button 14 and the display 15 are installed to correspond to the product on the product display shelf unit. The button 14 is one of the above-described buttons 14-1 to 14-N. The display 15 is one of the above-described displays 15-1 to 15-N.

When the button 14 is pressed, the decision unit 33 decides whether the press is any of the first press or the second press. The first press of the button 14 includes a press of the button 14 in a state in which the result of the stock check is not displayed on the display 15 or a press of the button 14 after the prescribed time elapses from the immediately previous press of the button 14. The second press of the button 14 includes a press of the button 14 in a state in which the result of the stock check is displayed on the display 15 or a press of the button 14 performed before the prescribed time elapses from the immediately previous press of the button 14.

The transmission unit 31 transmits a signal (first signal), which causes the stock check of the product to be performed, to the server in response to the first press of the button 14. Furthermore, the transmission unit 31 transmits a signal (second signal), which causes a notification to be provided to the sales clerk, to the server in response to the second press of the button 14.

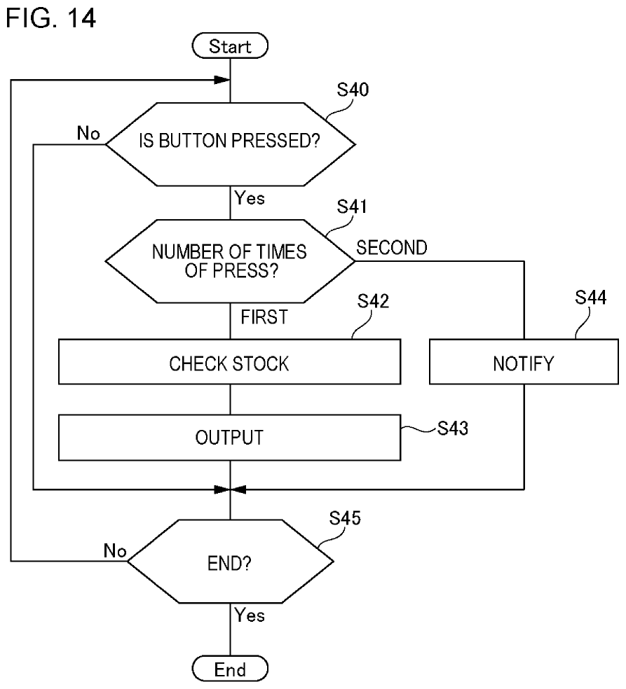

Subsequently, an example of a flow of a process performed by the store system 20 of the example embodiment will be described with reference to a flowchart of FIG. 14. It should be noted that, the store system 20 may perform, in addition to the process, the processes illustrated in the flowcharts of FIGS. 7 and 8 which are described in the first example embodiment.

The store system 20 is in a waiting state for the press of the plurality of buttons 14-1 to 14-N (S40). While there is no input to end the process (No in S45), the store system 20 continues the waiting state.

In a case where the press is performed on any button 14-B (Yes in S40), the decision unit 33 decides the number of times of the press (S41). In a case of the first press, the check unit 16 performs the stock check of the product corresponding to the button 14-B (S42). Furthermore, the display control unit 17 displays the result of the stock check on the display 15-B corresponding to the product (S43). Thereafter, while there is no input to end the process (No in S45), the store system 20 repeats the same process.

On the other hand, in a case of the second press, the notification unit 18 provides a notification of the second press to the sales clerk (S44). Thereafter, while there is no input to end the process (No in S45), the store system 20 repeats the same process.

Hereinabove, according to the above-described store system 20 of the example embodiment, it is possible to achieve the same advantageous effect as those of the first and second example embodiments.

In addition, according to the store system 20 of the example embodiment, it is possible to cause each of the buttons 14-1 to 14-N to have two functions of “requesting the stock check” and “calling the sales clerk”. As a result, it is possible to reduce burden on an installation apparatus and to cause the store system 20 to have necessary functions. In addition, there is a case where the customer viewing the result of the stock check makes it unnecessary to call the sales clerk. In a case where a configuration of “calling the sales clerk after the result of the stock check is displayed” is made, it is possible to reduce a trouble of unnecessarily calling the sales clerk. In addition, it may be assumed that a customer presses the button out of curiosity while not intending to perform the stock check or call the sales clerk. In this regard, the configuration of “calling the sales clerk after the result of the stock check is displayed” is made, and thus it is possible to cause the customer to check a stock situation by the first press and to call the sales clerk by the second press after, for example, checking the customer's intention of purchase. As a result, it is possible to resolve a trouble that the button is pressed out of curiosity, a request for displaying the product is notified to the sales clerk although the product is displayed, or that the sales clerk is unnecessarily called.

Hereinafter, examples of a reference form will be described.

1. A store system including:

a plurality of information acquisition units that are installed on a product display shelf unit so as to correspond to a plurality of products, respectively;

a registration unit that, when customer identification information is input through a first information acquisition unit, registers the customer identification information in a notification list in association with the product corresponding to the first information acquisition unit; and

a transmission unit that transmits relevant information of the product which is associated with each piece of customer identification information registered in the notification list to a transmission destination corresponding to the customer identification information.

2. The store system of 1,

in which the relevant information includes at least one of an expected next arrival date of the product, a next arrival date of the product, an arrival notification of the product, and an URL.

3. The store system of 2,

in which the URL is a URL of a website which is used to specify whether or not to reserve the product.

4. The store system of 2,

in which the URL is a URL of a website which is used to perform a settlement procedure of the product.

5. The store system of 4,

in which the website receives a specification of a method for receiving the product.

6. The store system of 5,

in which, as the method for receiving the product, it is possible to specify at least one of receipt at a store and delivery to a specified address.

7. The store system of any one of 1 to 6, further including:

a plurality of buttons that are installed on the product display shelf unit so as to correspond to the plurality of products, respectively;

a plurality of displays that are installed on the product display shelf unit so as to correspond to the plurality of products, respectively;

a check unit that, when the button is pressed, performs a stock check of the product of which the button is pressed; and

a display control unit that displays a result of the stock check on the display corresponding to the product of which the button is pressed.

8. A store system including:

a plurality of buttons that are installed on a product display shelf unit so as to correspond to a plurality of products, respectively;

a plurality of displays that are installed on the product display shelf unit so as to correspond to the plurality of products, respectively;

a check unit that performs stock check of the product of which the button is pressed in response to a first press of the button;

a display control unit that displays a result of the stock check on the display corresponding to the product of which the button is pressed; and

a notification unit that provides a notification to a sales clerk in response to a press of the button in a state in which the result of the stock check is displayed on the display or a second press corresponding to a press of the button which is performed before a prescribed time elapses from an immediately previous press of the button,

in which the first press of the button includes a press of the button in a state in which the result of the stock check is not displayed on the display or a press of the button which is performed after the prescribed time elapses from the immediately previous press of the button.

9. An electronic shelf label including:

a button that is installed on a product display shelf unit so as to correspond to a product;

a display that is installed on the product display shelf unit so as to correspond to the product; and

a transmission unit that transmits a signal, which causes stock check of the product to be performed, to a server in response to a first press of the button, and transmits a signal, which causes a notification to be provided to a sales clerk, in response to a press of the button in a state in which a result of the stock check is displayed on the display, or a second press corresponding to a press of the button which is performed before a prescribed time elapses from an immediately previous press of the button,

in which the first press of the button includes a press of the button in a state in which the result of the stock check is not displayed on the display, or a press of the button which is performed after the prescribed time elapses from the immediately previous press of the button.

10. A processing method for a store system, which is executed by a computer of the store system that includes a plurality of information acquisition units installed on a product display shelf unit so as to correspond to a plurality of products, respectively, the method including:

a registration step of, when customer identification information is input through a first information acquisition unit, registering the customer identification information in a notification list in association with the product corresponding to the first information acquisition unit; and

a transmission step of transmitting relevant information of the product which is associated with each piece of customer identification information registered in the notification list to a transmission destination corresponding to the customer identification information.

11. A program causing a computer of a store system that includes a plurality of information acquisition units installed on a product display shelf unit so as to correspond to a plurality of products, respectively, to function as:

a registration unit that, when customer identification information is input through a first information acquisition unit, registers the customer identification information in a notification list in association with the product corresponding to the first information acquisition unit; and

a transmission unit that transmits relevant information of the product which is associated with each piece of customer identification information registered in the notification list to a transmission destination corresponding to the customer identification information.

12. A processing method for a store system, which is executed by a computer of the store system that includes a plurality of buttons that are installed on a product display shelf unit so as to correspond to a plurality of products, respectively and a plurality of displays that are installed on the product display shelf unit so as to correspond to the plurality of products, respectively, the method including:

a check step of performing stock check of the product of which the button is pressed in response to a first press of the button;

a display control step of displaying a result of the stock check on the display corresponding to the product of which the button is pressed; and

a notification step of providing a notification to a sales clerk in response to a press of the button in a state in which the result of the stock check is displayed on the display or a second press corresponding to a press of the button, which is performed before a prescribed time elapses from an immediately previous press of the button,

in which the first press of the button includes a press of the button in a state in which the result of the stock check is not displayed on the display, or a press of the button which is performed after the prescribed time elapses from the immediately previous press of the button.

13. A program causing a computer of a store system that includes a plurality of buttons that are installed on a product display shelf unit so as to correspond to a plurality of products, respectively and a plurality of displays that are installed on the product display shelf unit so as to correspond to the plurality of products, respectively, to function as:

a check unit that performs stock check of the product of which the button is pressed in response to a first press of the button;

a display control unit that displays a result of the stock check on the display corresponding to the product of which the button is pressed; and

a notification unit that provides a notification to a sales clerk in response to a press of the button in a state in which the result of the stock check is displayed on the display or a second press corresponding to a press of the button, which is performed before a prescribed time elapses from an immediately previous press of the button,

in which the first press of the button includes a press of the button in a state in which the result of the stock check is not displayed on the display, or a press of the button which is performed after the prescribed time elapses from the immediately previous press of the button.

This application claims priority based on Japanese Patent Application No. 2017-070084 filed on Mar. 31, 2017, and the content of the application is incorporated herein by reference in its entirety.

1. A store system comprising:
a plurality of information acquisition units that are installed on a product display shelf unit so as to correspond to a plurality of products, respectively;
at least one memory configured to store one or more instructions; and
at least one processor configured to execute the one or more instructions to:
when customer identification information is input through a first information acquisition unit, register the customer identification information in a notification list in association with the product corresponding to the first information acquisition unit; and
transmit relevant information of the product which is associated with each piece of customer identification information registered in the notification list to a transmission destination corresponding to the customer identification information.

2. The store system according to claim 1,
wherein the relevant information includes at least one of an expected next arrival date of the product, a next arrival date of the product, an arrival notification of the product, and an URL.

3. The store system according to claim 2,
wherein the URL is a URL of a website which is used to specify whether or not to reserve the product.

4. The store system according to claim 2,
wherein the URL is a URL of a website which is used to perform a settlement procedure of the product.

5. The store system according to claim 4,
wherein the website receives a specification of a method for receiving the product.

6. The store system according to claim 5,
wherein, as the method for receiving the product, it is possible to specify at least one of receipt at a store and delivery to a specified address.

7. The store system according to claim 1, further comprising:
a plurality of buttons that are installed on the product display shelf unit so as to correspond to the plurality of products, respectively;
a plurality of displays that are installed on the product display shelf unit so as to correspond to the plurality of products, respectively;
wherein the processor is further configured to execute the one or more instructions to:
when the button is pressed, perform a stock check of the product of which the button is pressed; and
display a result of the stock check on the display corresponding to the product of which the button is pressed.

8. A store system comprising:
a plurality of buttons that are installed on a product display shelf unit so as to correspond to a plurality of products, respectively;
a plurality of displays that are installed on the product display shelf unit so as to correspond to the plurality of products, respectively;
at least one memory configured to store one or more instructions; and
at least one processor configured to execute the one or more instructions to:
perform stock check of the product of which the button is pressed in response to a first press of the button;
display a result of the stock check on the display corresponding to the product of which the button is pressed; and
provides provide a notification to a sales clerk in response to a press of the button in a state in which the result of the stock check is displayed on the display or a second press corresponding to a press of the button which is performed before a prescribed time elapses from an immediately previous press of the button,
wherein the first press of the button includes a press of the button in a state in which the result of the stock check is not displayed on the display or a press of the button which is performed after the prescribed time elapses from the immediately previous press of the button.

9. An electronic shelf label comprising:
a button that is installed on a product display shelf unit so as to correspond to a product;
a display that is installed on the product display shelf unit so as to correspond to the product;
at least one memory configured to store one or more instructions; and
at least one processor configured to execute the one or more instructions to:
transmit a signal, which causes stock check of the product to be performed, to a server in response to a first press of the button, and transmit a signal, which causes a notification to be provided to a sales clerk, in response to a press of the button in a state in which a result of the stock check is displayed on the display, or a second press corresponding to a press of the button which is performed before a prescribed time elapses from an immediately previous press of the button,
wherein the first press of the button includes a press of the button in a state in which the result of the stock check is not displayed on the display, or a press of the button which is performed after the prescribed time elapses from the immediately previous press of the button.

10. A processing method for a store system, which is executed by a computer of the store system that comprises a plurality of information acquisition units installed on a product display shelf unit so as to correspond to a plurality of products, respectively, the method comprising:
when customer identification information is input through a first information acquisition unit, registering the customer identification information in a notification list in association with the product corresponding to the first information acquisition unit; and
transmitting relevant information of the product which is associated with each piece of customer identification information registered in the notification list to a transmission destination corresponding to the customer identification information.

11. A non-transitory storage medium storing a program causing a computer of a store system that includes a plurality of information acquisition units installed on a product display shelf unit so as to correspond to a plurality of products, respectively, to:
when customer identification information is input through a first information acquisition unit, registers register the customer identification information in a notification list in association with the product corresponding to the first information acquisition unit; and
transmit relevant information of the product which is associated with each piece of customer identification information registered in the notification list to a transmission destination corresponding to the customer identification information.

12. A processing method for a store system, which is executed by a computer of the store system that comprises a plurality of buttons that are installed on a product display shelf unit so as to correspond to a plurality of products, respectively and a plurality of displays that are installed on the product display shelf unit so as to correspond to the plurality of products, respectively, the method comprising:
performing stock check of the product of which the button is pressed in response to a first press of the button;
displaying a result of the stock check on the display corresponding to the product of which the button is pressed; and
providing a notification to a sales clerk in response to a press of the button in a state in which the result of the stock check is displayed on the display or a second press corresponding to a press of the button which is performed before a prescribed time elapses from an immediately previous press of the button,
wherein the first press of the button includes a press of the button in a state in which the result of the stock check is not displayed on the display or a press of the button which is performed after the prescribed time elapses from the immediately previous press of the button.

13. A non-transitory storage medium storing a program causing a computer of a store system that comprises a plurality of buttons that are installed on a product display shelf unit so as to correspond to a plurality of products, respectively and a plurality of displays that are installed on the product display shelf unit so as to correspond to the plurality of products, respectively, to:
perform stock check of the product of which the button is pressed in response to a first press of the button;
display a result of the stock check on the display corresponding to the product of which the button is pressed; and
provide a notification to a sales clerk in response to a press of the button in a state in which the result of the stock check is displayed on the display or a second press corresponding to a press of the button which is performed before a prescribed time elapses from an immediately previous press of the button,
wherein the first press of the button includes a press of the button in a state in which the result of the stock check is not displayed on the display, or a press of the button which is performed after the prescribed time elapses from the immediately previous press of the button.
